(19) United States
(12) Patent Application Publication
(10) Pub. No.: US 2002/0003631 A1
(43) Pub. Date: Jan. 10, 2002

(54) System and method for producing a coloring book image from a digital image

(76) Inventors: Philip M. Abram, Warwick, NJ (US); Eric Edwards, San Francisco, CA (US)

Correspondence Address: Intellectual Property Department, Sony Electronics Inc., 123 Tice Boulevard - MD T1-1, Woodcliff Lake, NJ, 07677-8402, US

(21) Appl. No.: 09/800,713

(22) Filed: Mar. 6, 2001

Related U.S. Application Data
(60) Provisional application No. 60/187,332, filed on Mar. 6, 2000.

(51) Int. Cl. G06F 15/00

(52) U.S. Cl. 358/1.9; 358/1.18

(57) ABSTRACT

A method and system for producing a coloring book image from a digital image are described. In one embodiment, a line-art image is rendered from a digital image. The line-art image is formatted to produce a coloring book image and the coloring book image is printed.

This application claims benefit of U.S. Provisional Application No. 60/187,332 filed Mar. 6, 2000.

### FIELD OF THE INVENTION

The present invention relates generally digital imaging. In particular, the present invention relates to the production of coloring book images from digital images.

### BACKGROUND OF THE INVENTION

Coloring book images have traditionally been created by a printing method and the images have traditionally been purchased in book form. With the advent of digital images, consumers wish to create personalized and specialized coloring book images from their own digital images. Although it is well know to render line-art images from digital images, there is currently no method or system to automatically create coloring book images from digital images.

### SUMMARY OF THE INVENTION

A method and system for producing a coloring book image from a digital image are described. In one embodiment, a line-art image is rendered from a digital image. The line-art image is formatted to produce a coloring book image and the coloring book image is printed.

### BRIEF DESCRIPTION OF THE DRAWINGS

Features and advantages of the present invention will be apparent to one skilled in the art in light of the following detailed description in which:

FIG. 1 is a block diagram of one embodiment for a distributed coloring book production system;

FIG. 2 is a block diagram for one embodiment of an architecture for a computer system;

FIG. 3 is a block diagram of one embodiment for a non-volatile memory of FIG. 2;

FIG. 4 is an exemplary digital image;

FIG. 5 is an exemplary line-art image;

FIG. 6 is an exemplary coloring book image;

FIG. 7 is an exemplary color-by-numbers coloring book image;

FIG. 8 is an exemplary coloring book storyboard;

FIG. 9 is a flow diagram of one embodiment for automatically producing a coloring book image from a digital image;

FIG. 10 is a flow diagram of one embodiment for automatically producing a coloring book image from a digital image over a distributed system;

FIG. 11 is a flow diagram of one embodiment for automatically printing a coloring book image produced from a digital image at a client; and

FIG. 12 is a flow diagram of one embodiment for automatically producing a coloring book image from a digital image at a server.

### DETAILED DESCRIPTION

A method and system for producing a coloring book image from a digital image are described. In one embodiment, a line-art image is rendered from a digital image. The line-art image is formatted to produce a coloring book image and the coloring book image is printed.

In the following detailed description, numerous specific details are set forth in order to provide a thorough understanding of the embodiments. However, it will be apparent to one skilled in the art that the embodiments may be practiced without these specific details. In some instances, well-known structures and devices are shown in block diagram form, rather than in detail, in order to avoid obscuring the embodiments.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The embodiments also relate to a system for performing the operations herein. This system may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings of the embodiments as described herein.

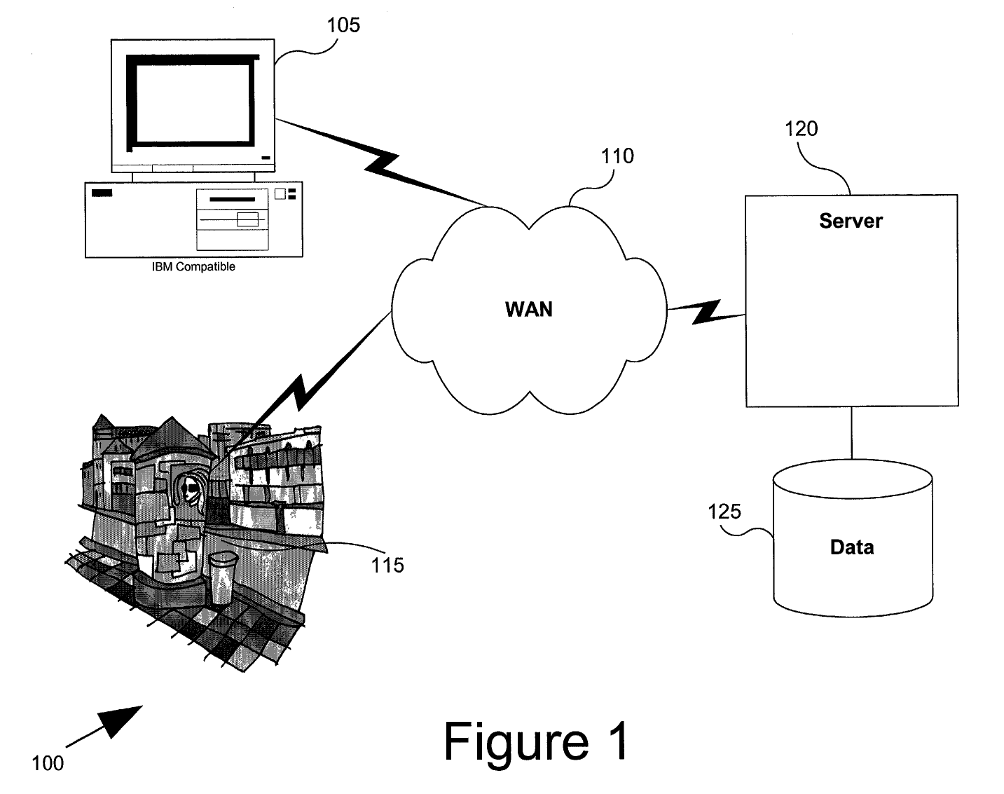

FIG. 1 is a block diagram of one embodiment for a distributed coloring book production system 100. Referring to FIG. 1, server 120 is connected to mass storage device 125. Server 120 and mass storage device 125 are connected via wide area network (WAN) 110 to a number of clients 105 and 115. Wide area network 110 may be connected to any of a variety of clients 105 and 115. Clients 105 and 115 may be, for example, a personal computer 105 or a client at a public kiosk 115. In the discussion that follows, the term client may be used interchangeably for a personal computer 105, public kiosk 115, or any other suitable system access device.

In one embodiment, a user loads a digital image into client 105. Any suitable means for loading the digital image may be used such as, for example, using a digital scanner, a digital camera, memory stick, digital camcorder, or the like. The digital image may be any digital image such as, for example, an eight-bit or sixteen-bit grayscale image, an eight-bit duotone image, an eight-bit paletted image, a sixteen-bit, twenty-four-bit, thirty-two-bit, or forty-eight-bit color image, or the like. In one embodiment, the digital image may be transmitted from client 105 via WAN 110 to server 120. At server 120, a line-art image may be rendered from the digital image and a coloring book image may be formatted from the line-art image. The line-art image may be rendered from the digital image by any well-known rotoscoping technique. The coloring book image may be transmitted to client 105 and printed. In an alternate embodiment, the rendering and/or formatting may be performed on client 105 or a part of the coloring book image production process may be performed on client 105 and server 120. In an alternate embodiment, the printing of the coloring book image may be performed at a server 120 site and the printed image shipped to the user. Alternatively, the coloring book image may be transmitted to another site (server or client site) at the user's direction and subsequently printed.

In one embodiment, the user may load the digital image at public kiosk 115. Public kiosk 115 may be located, for example, in a shopping center or at a store location. Public kiosk 115 includes a suitable system access device for interacting with server 120. For example, the system access device may be a cradle for docking a memory stick or digital camera and a means for contacting and interacting with server 120, such as a keyboard. The digital image may be rendered and formatted into the coloring book image at server 120 and the coloring book image may be printed at public kiosk 115. In an alternate embodiment, the coloring book image may be printed at server 120 or other site and shipped to the user by direct mail or other appropriate means. Alternatively, the entire process of producing the coloring book image from the digital image may be performed at public kiosk 115. In one embodiment, a fee may be charged for printing the coloring book image. In an alternate embodiment, a fee may be charged for rendering, formatting, and printing the image.

In any of the embodiments described above, the coloring book image may be transmitted to another site for printing, such as, for example, to another client 105, 115 or to another server 120 site.

In any embodiment described above, color samples may be generated from the digital image and a fixed or programmable palette of colors may be assigned to image areas of the coloring book image. Further, an index number may be assigned to a corresponding sample color and the index number and color may be printed with the coloring book image to produce a color-by-numbers coloring book image. The coloring book images generated in any of the embodiments described above may be combined with stock line-art images to generate a storyboard. The storyboard may be printed in the form of a coloring book.

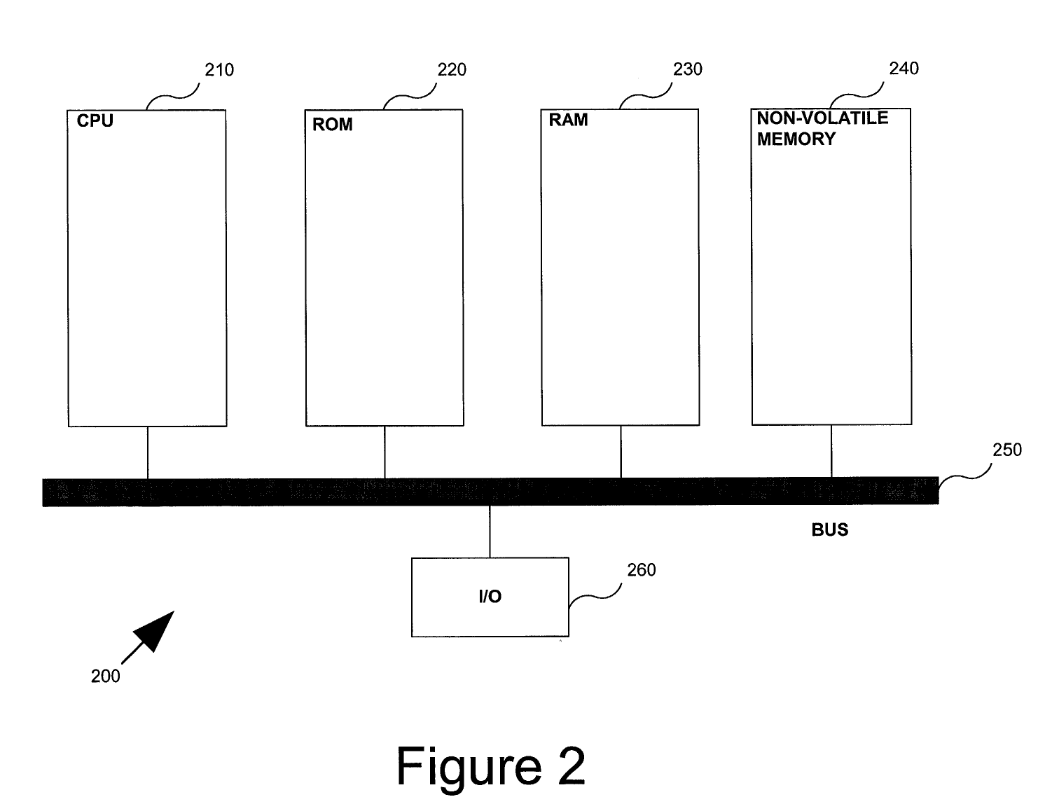

FIG. 2 is a block diagram of one embodiment of an architecture for a computer system 200. Computer system 200 may be used for client 105 or public kiosk 115, or server 120. Referring to FIG. 2, CPU 210 is coupled via a bus 250 to a variety of memory structures and input/output (I/O) 260 such as, for example, a printer. The memory structures may include read only memory (ROM) 220, random access memory (RAM) 230, and/or non-volatile memory 240. In one embodiment, CPU 210 may also be coupled via bus 250 to a network interface. The network interface may be used to communicate between computer system 200 and a variety of other clients, servers, and computers via a wide area network such as, for example, the Internet or communicate over a local area network. The network interface may be coupled to wide area network 110 by any of a variety of means such as, for example, a telephone connection via modem, a DSL line, a wireless connection, or the like.

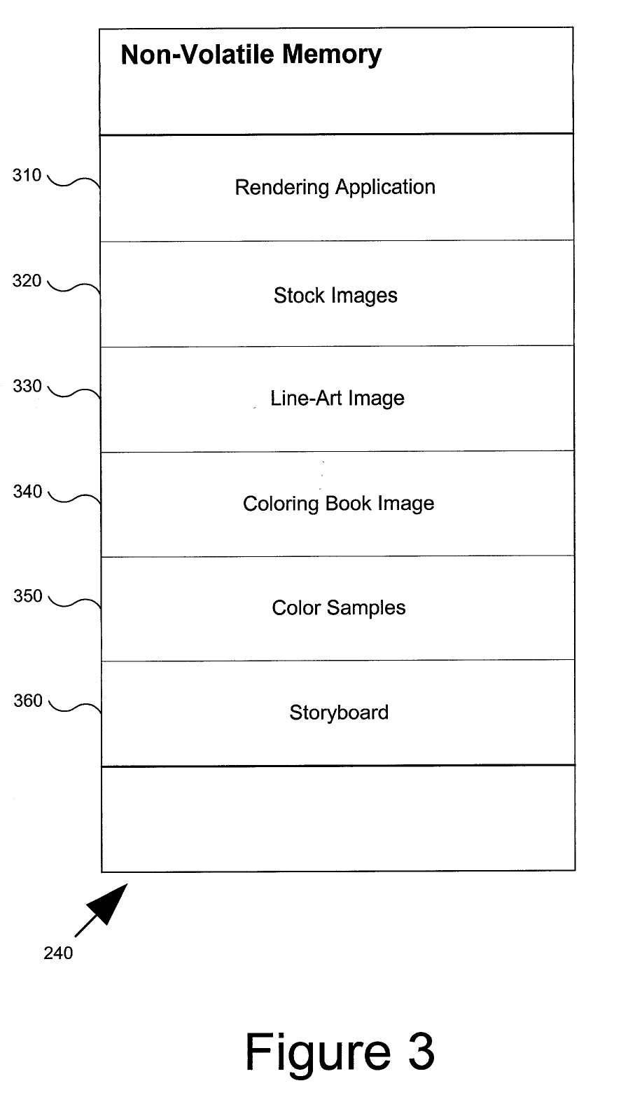

FIG. 3 is a block diagram of one embodiment for non-volatile memory 240 of FIG. 2. Referring to FIG. 3, non-volatile memory 240 contains rendering application 310, stock images 320, line-art image 330, coloring book image 340, color samples 350, and storyboard 360. Although described as a single application, rendering application 310 may consist of a number of separate applications maintained within separate locations or memory. Although described as a single image, line-art image 330 and coloring book image 340 may contain one or more images.

In one embodiment, rendering application 310 may be used to render a digital image into line-art image 330. In addition, rendering application 310 may be used to format line-art image 330 into coloring book image 340. Further, rendering application 310 may be used to generate a number of color samples 350 from the digital image. Color samples 350 may be generated from fixed color palettes or may be programmable palettes. Color samples 350 represent the paletted colors of image areas of the original digital image. For example, if the original digital image is of a face, the color samples 350 may correspond to the lips, hair, or the like. Color samples 350 may be assigned an index number corresponding to the given image area and the color, color name, and/or index number may be printed together with the color book image 340. Stock images 320 contain a number of digital images that may be combined with coloring book image 340 to produce storyboard 360. Storyboard 360 may be printed as a coloring book that consists of a number of coloring book images 340. Storyboard 360 images may be printed with or without color samples 350.

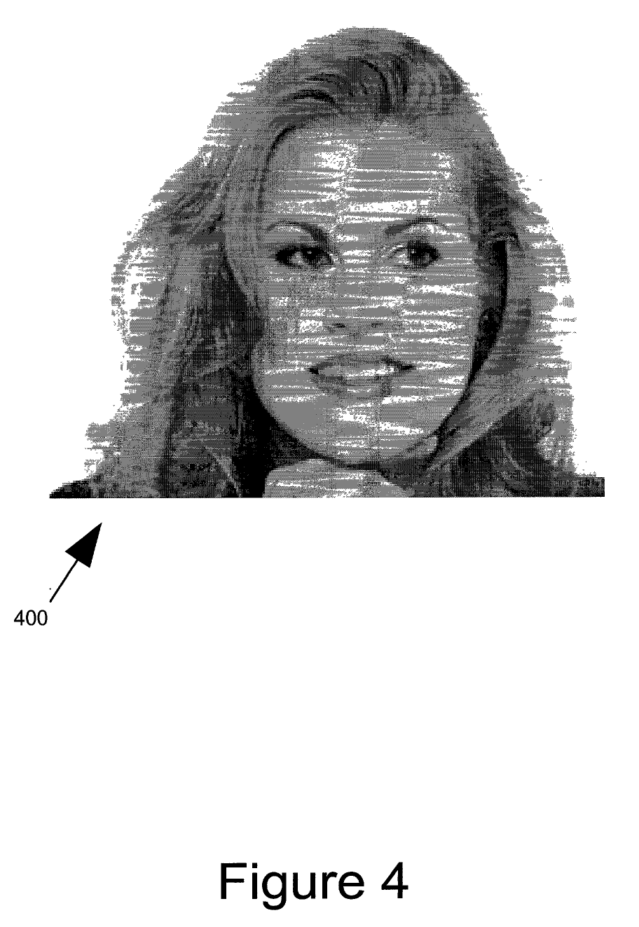

FIG. 4 is an exemplary digital image 400. Referring to FIG. 4, digital image 400 may be any mode of digital image such as, for example, an eight-bit or sixteen-bit grayscale image, an eight-bit duotone image, an eight-bit paletted image, a sixteen-bit, twenty-four-bit, thirty-two-bit, or forty-eight-bit color image, or the like. In one embodiment, digital image 400 is a high-bit-mode digital image that is rendered into a line-art image by any well-known rotoscoping process.

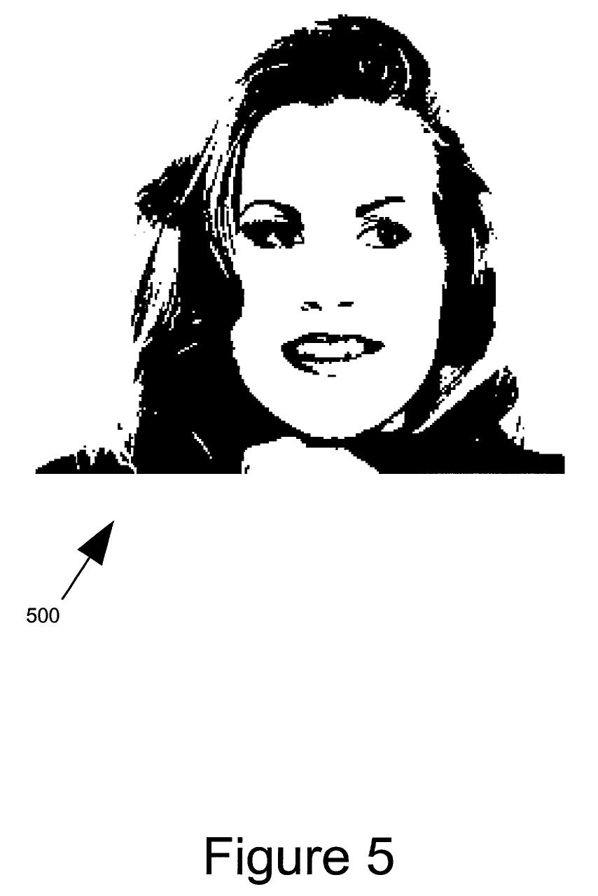

FIG. 5 is an exemplary line-art image 500. Referring to FIG. 5, line-art image 500 may be rendered from digital image 400. Any of a variety of well know rotoscoping methods may be used to produce line-art image 500 from digital image 400. For example, a number of well known image filters may be used to reduce and change the mode of a digital image by using edge detection, mode reduction, or the like.

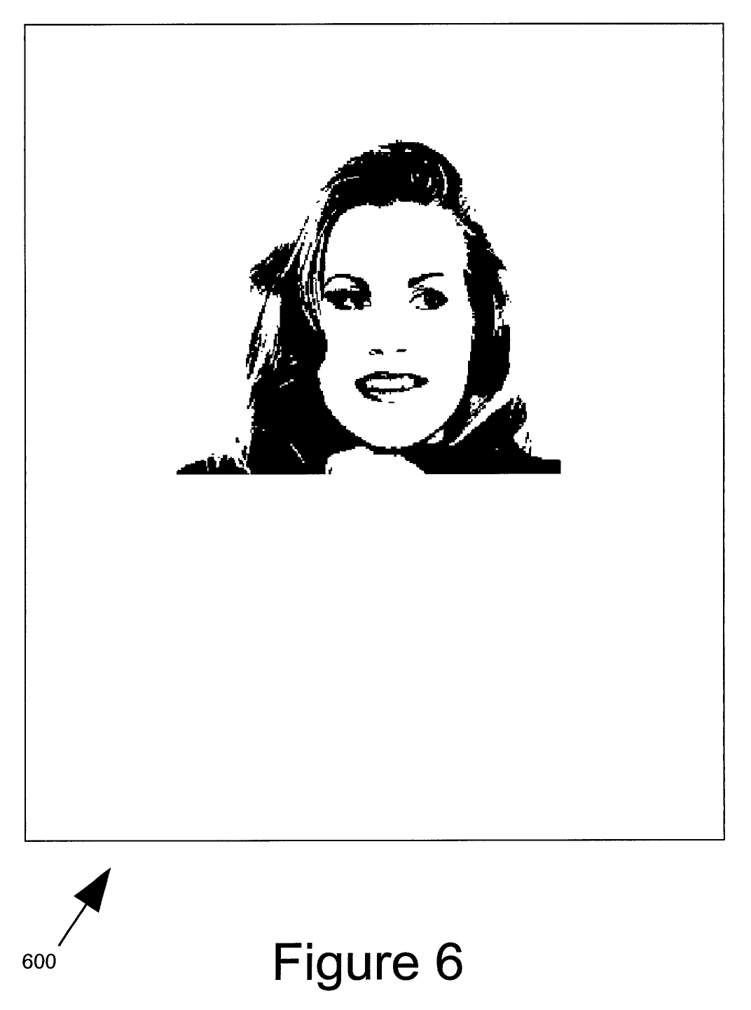

FIG. 6 is an exemplary coloring book image 600. Referring to FIG. 6, coloring book image 600 is formatted from line-art image 500. Coloring book image 600 is formatted so that the image is properly placed on the page for printing by any standard printing process. Coloring book image 600 is formatted so that line-art image 500 is fully visible on the printed page. In one embodiment, a single image is formatted into coloring book image 600. Alternatively, a number of images may be formatted so as to fit onto coloring book image 600.

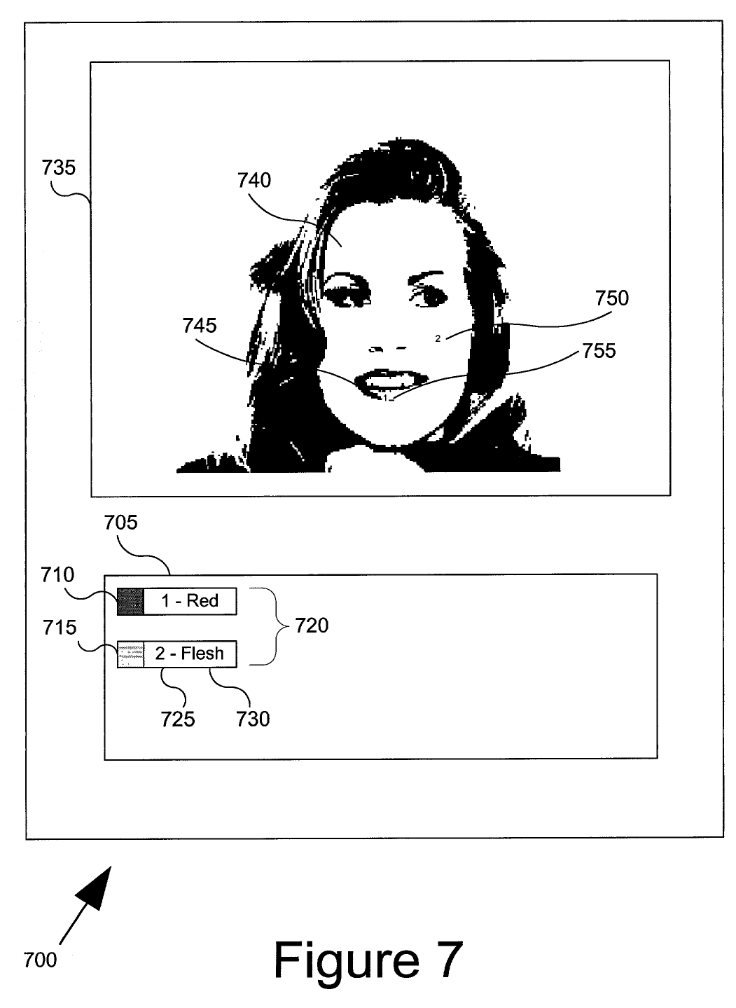

FIG. 7 is an exemplary color-by-numbers coloring book image 700. Referring to FIG. 7, color-by-numbers coloring book image 700 includes color index 705, and image 735. Color index 705 includes color palette 710, 715 and color index 720. Color index 720 includes index number 725 and color name 730. Image 735 includes image areas 740, 745. Image areas 740, 745 include color number 750, 755. Color number 750 corresponds to index number 725 which indicates, for example, that image area 740, having a color number 750 of “2” corresponds to index number 725 and name 730 and that image area 740 should be colored the color represented by color palette 715. Color palettes 710, 715 are generated from digital image 400 and are a paletted representation of the original colors of image areas 740, 745 within digital image 400. Any well know means for generating color palettes 710, 715 may be used to generate color index 705.

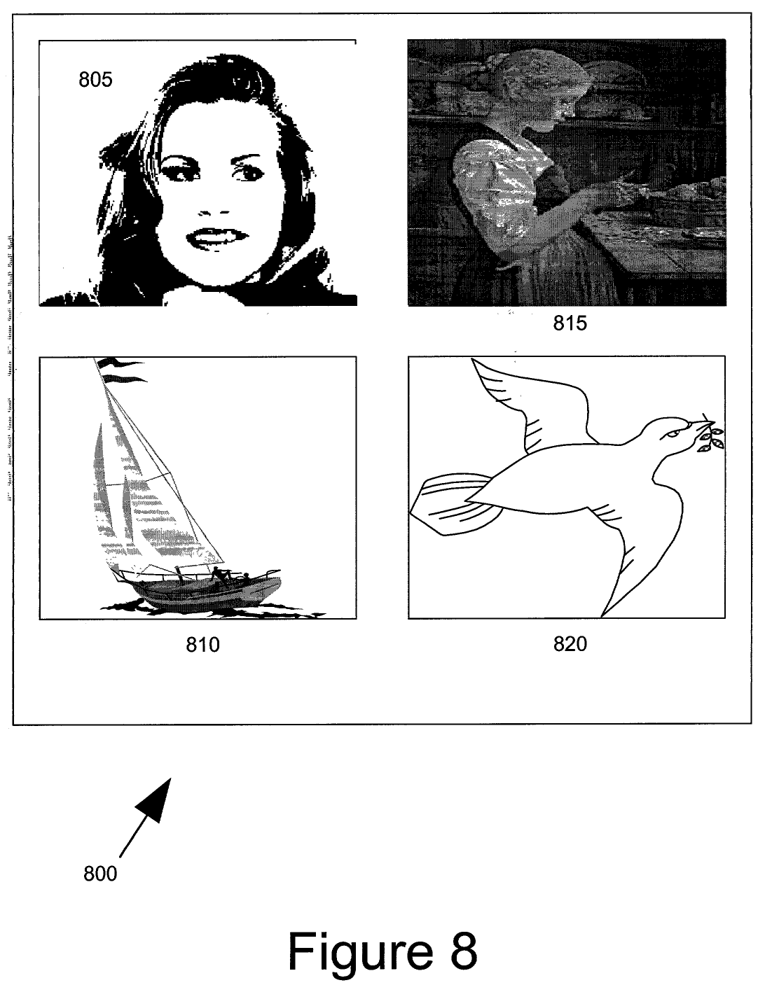

FIGS. 8 is an exemplary coloring book storyboard 800. Referring to FIG. 8, coloring book storyboard 800 includes line-art image 805 and stock images 810, 815, 820. Line-art image 805 may be combined with stock images 810, 815, 820 to create coloring book storyboard 800. Coloring book storyboard 800 may be generated automatically or at the direction of the user. The user may choose which stock images 810, 815, 820 may be included in coloring book storyboard 800 and in which order. In one embodiment, a number of stock images together with any number of line-art images may be combined to generate coloring book storyboard 800. Any number of means may be used to manipulate line-art image 805 and stock images 810, 815, 820 to produce storyboard 800. For example, the user may choose images by placing a number representing the order of the images within coloring book storyboard 800 in a suitable area within a display or may drag the images from the image display area to coloring book storyboard 800. The user may then rearrange the images on coloring book storyboard 800.

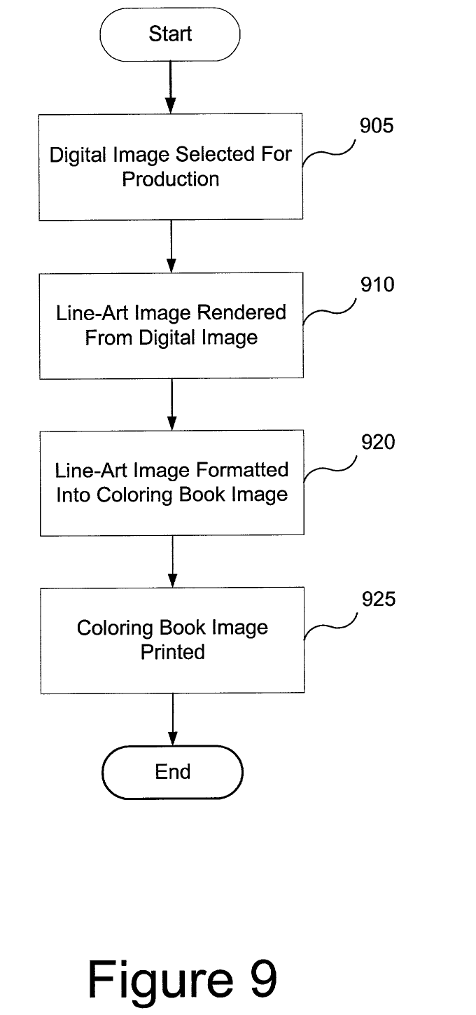

FIG. 9 is a flow diagram of one embodiment for automatically producing a coloring book image from a digital image. At processing block 905, digital image 400 is selected for production. Digital image 400 may be any digital image such as, for example, an eight-bit or sixteen-bit grayscale image, an eight-bit duotone image, an eight-bit paletted image, a sixteen-bit, twenty-four-bit, thirty-two-bit, or forty-eight-bit color image, or the like.

At processing block 910, line-art image 500 is rendered from digital image 400. Line-art image 500 may be rendered from digital image 400 by any well-known rotoscoping technique. In one embodiment, color samples 350 may be generated from digital image 400 and assigned to a corresponding image area 740 of line-art image 500. In one embodiment, index number 725 may be assigned to a corresponding color sample 350.

At processing block 920, line-art image 500 is formatted into coloring book image 600. In one embodiment, color index 705 may be generated and formatted together with line-art image 500 to produce coloring book image 600. In an alternate embodiment, line-art image 500 may be formatted with stock images 320 to generate coloring book storyboard 800. In this alternate embodiment, color index 705 may be formatted with line-art image 500 and stock images 320 to generate coloring book storyboard 800.

At processing block 925, coloring book image 600 is printed. In one embodiment, coloring book image 600 may be printed. In an alternate embodiment, color-by-numbers coloring book image 700 may be printed. In another alternate embodiment, coloring book storyboard 800 may be printed.

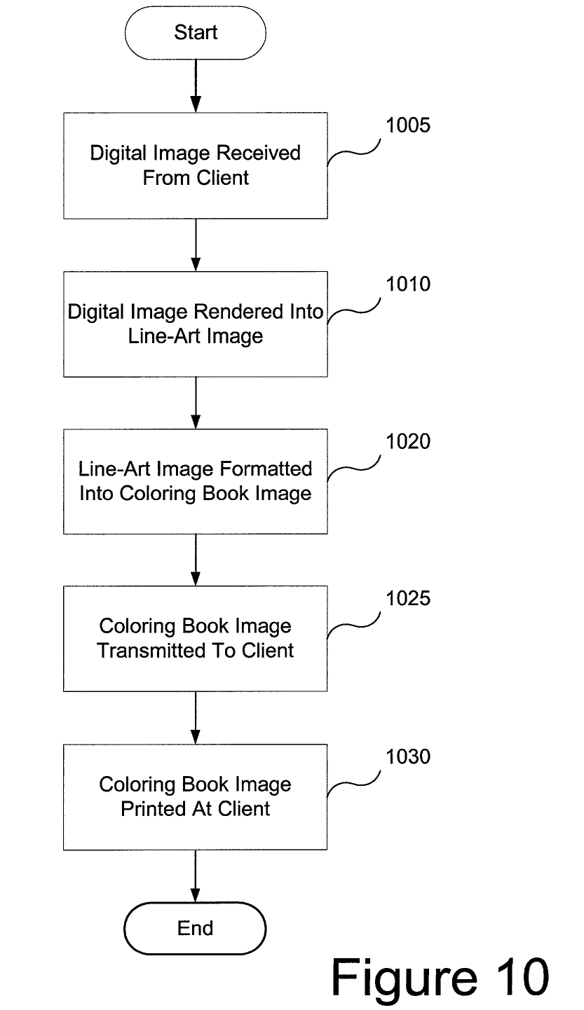

FIG. 10 is a flow diagram of one embodiment for automatically producing coloring book image 600 from digital image 400 over distributed system 100. At processing block 1005, digital image 400 is received from client 105, 115 at server 120.

At processing block 1010, digital image 400 is rendered into line-art image 500. Any well known rotoscoping process may be used to render line-art image 500.

At processing block 1020, line-art image 500 is formatted into coloring book image 600. In one embodiment, color index 705 may be generated and formatted together with line-art image 500 to produce coloring book image 600. In an alternate embodiment, line-art image 500 may be formatted with stock images 320 to produce coloring book storyboard 800. In this alternate embodiment, color index 705 may alternatively be formatted with line-art image 500 and stock images 320 to produce coloring book storyboard 800.

At processing block 1025, coloring book image 600 is transmitted to client 105, 115. In one embodiment, coloring book image 600 may be transmitted to client 105, 115. In an alternate embodiment, color-by-numbers coloring book image 700 may be transmitted to client 105, 115. In another alternate embodiment, coloring book storyboard 800 may be transmitted to client 105, 115.

At processing block 1030, coloring book image 600 is printed at client 105, 115. In an alternate embodiment, color-by-numbers coloring book image 700 may be printed. In another alternate embodiment, coloring book storyboard 800 may be printed. In an alternate embodiment, coloring book image 600 may be transmitted via WAN 110 to an alternative server 120 site or client 105, 115 for printing.

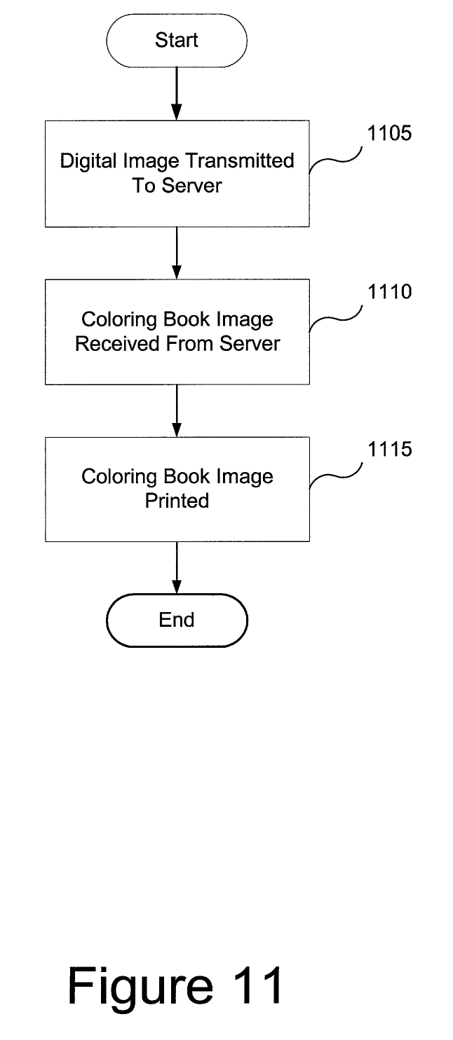

FIG. 11 is a flow diagram of one embodiment for automatically printing coloring book image 600 produced from digital image 400 at client 105, 115. At processing block 1105, digital image 400 is transmitted from client 105, 115 to server 120.

At processing block 1110, coloring book image 600 is received from server 120 at client 105, 115. Coloring book image has been rendered and formatted from digital image 400. In one embodiment, coloring book image 600 may be received. In an alternate embodiment, color-by-numbers coloring book image 700 may be received. In another alternate embodiment, coloring book storyboard 800 may be received.

At processing block 1115, coloring book image 600 is printed at client 105, 115. In one embodiment, coloring book image 600 may be printed. In an alternate embodiment, color-by-numbers coloring book image 700 may be printed. In another alternate embodiment, coloring book storyboard 800 may be printed.

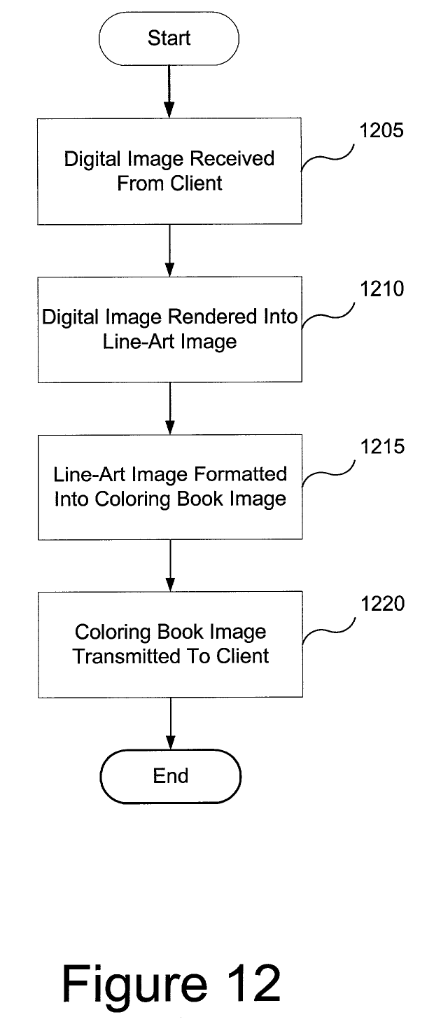

FIG. 12 is a flow diagram of one embodiment for automatically producing coloring book image 600 from digital image 400 at server 120. At processing block 1205, digital image 400 is received from client 105, 115.

At processing block 1210, digital image 400 is rendered into line-art image 500. Line-art image 500 may be rendered from digital image 400 by any well-known rotoscoping technique. In one embodiment, color sample 350 may be generated from digital image 400 and assigned to a corresponding image area of line-art image 500. In one embodiment, index number 725 corresponding to sample color 350 may be assigned.

At processing block 1215, line-art image 500 is formatted into coloring book image 600. In one embodiment, line-art image 500 may be rendered into coloring book image 600. In an alternate embodiment, line-art image 500 may be rendered into color-by-numbers coloring book image 700. In another alternate embodiment, line-art image 500 may be rendered into coloring book storyboard 800.

At processing block 1220, coloring book image 600 is transmitted to client 105, 115. In one embodiment, coloring book image 600 may be transmitted. In an alternate embodiment, color-by-numbers coloring book image 700 may be transmitted. In another alternate embodiment, coloring book storyboard 800 may be transmitted. In an alternate embodiment, coloring book image 600, color-by-numbers coloring book image 700, or coloring book storyboard 800 may be transmitted to another server 120 site or to an alternate client 105, 115 from the client 105, 115 that the digital image 400 was received in processing block 1205.

The specific arrangements and methods herein are merely illustrative of the principles of this invention. Numerous modifications in form and detail may be made by those skilled in the art without departing from the true spirit and scope of the invention. What is claimed is:

1. A method comprising:
rendering a line-art image from a digital image;
formatting a coloring book image from the line-art image; and
printing the coloring book image.

2. The method of claim 1 further comprising:
generating at least one color sample from the digital image; and
assigning the at least one color sample to a corresponding image area of the line-art image.

3. The method of claim 2 further comprising:
assigning an index number corresponding to the at least one sample color; and
printing the index number with a name of the corresponding sampled color together with the coloring book image.

4. The method of claim 1 wherein the printing is performed at a public kiosk.

5. The method of claim 4 wherein a fee is charged for the printing at the public kiosk.

6. The method of claim 1 wherein the rendering, formatting, and printing is performed at a public kiosk.

7. The method of claim 6 wherein a fee is charged for the rendering, formatting, and printing at the public kiosk.

8. The method of claim 1 further comprising:
combining the coloring book image with stock images to produce a coloring book storyboard.

9. The method of claim 1 wherein the digital image is selected from the group consisting of an eight-bit grayscale image, an eight-bit duotone image, an eight-bit paletted image, a sixteen-bit grayscale image, a twenty-four-bit color image, a thirty-two-bit color image, and a forty-eight-bit color image.

10. A method comprising:
receiving a digital image at a server;
rendering a line-art image from the digital image;
formatting a coloring book image from the line-art image;
transmitting the coloring book image to a client; and
printing the coloring book image at the client.

11. The method of claim 10 further comprising:
generating at least one color sample from the digital image; and
assigning the at least one color sample to a corresponding image area of the line-art image.

12. The method of claim 11 further comprising:
assigning an index number corresponding to the at least one sample color; and
printing the index number with a name of the corresponding sampled color together with the coloring book image.

13. The method of claim 10 wherein the client is located at a public kiosk.

14. The method of claim 13 wherein a fee is charged for the printing at the public kiosk.

15. The method of claim 10 further comprising:
combining the coloring book image with stock images to produce a coloring book storyboard.

16. The method of claim 10 wherein the digital image is selected from the group consisting of an eight-bit grayscale image, an eight-bit duotone image, an eight-bit paletted image, a sixteen-bit grayscale image, a twenty-four-bit color image, a thirty-two-bit color image, and a forty-eight-bit color image.

17. A method comprising:
transmitting a digital image to a server;
receiving a coloring book image rendered from the digital image; and
printing the coloring book image.

18. The method of claim 17 wherein the printing is performed at a public kiosk.

19. The method of claim 18 wherein a fee is charged for the printing at the public kiosk.

20. The method of claim 17 wherein the digital image is selected from the group consisting of an eight-bit grayscale image, an eight-bit duotone image, an eight-bit paletted image, a sixteen-bit grayscale image, a twenty-four-bit color image, a thirty-two-bit color image, and a forty-eight-bit color image.

21. A method comprising:
receiving a digital image from a client;
rendering a line-art image from the digital image;
formatting a coloring book image from the line-art image.

22. The method of claim 21 further comprising:
transmitting the coloring book image to the client.

23. The method of claim 21 further comprising:
generating at least one color sample from the digital image; and
assigning the at least one color sample to a corresponding image area of the line-art image.

24. The method of claim 23 further comprising:
assigning an index number corresponding to the at least one sample color together with the coloring book image.

25. The method of claim 24 further comprising:
printing the index number with a name of the corresponding sampled color.

26. The method of claim 21 further comprising:
printing the coloring book image.

27. The method of claim 26 wherein the printing is performed at a public kiosk.

28. The method of claim 27 wherein a fee is charged for the printing at the public kiosk.

29. The method of claim 26 wherein the rendering, formatting, and printing is performed at a public kiosk.

30. The method of claim 29 wherein a fee is charged for the rendering, formatting, and printing at the public kiosk.

31. The method of claim 21 further comprising:
combining the coloring book image with stock images to produce a coloring book storyboard.

32. The method of claim 21 wherein the digital image is selected from the group consisting of an eight-bit grayscale image, an eight-bit duotone image, an eight-bit paletted image, a sixteen-bit grayscale image, a twenty-four-bit color image, a thirty-two-bit color image, and a forty-eight-bit color image.

33. A system comprising:
means for rendering a line-art image from a digital image;
means for formatting a coloring book image from the line-art image;
and
means for printing the coloring book image.

34. A system comprising:
means for receiving a digital image at a server;
means for rendering a line-art image from the digital image;
means for formatting a coloring book image from the line-art image;
means for transmitting the coloring book image to a client; and
means for printing the coloring book image at the client.

35. A system comprising:
means for transmitting a digital image to a server;
means for receiving a coloring book image rendered from the digital image; and
means for printing the coloring book image.

36. A system comprising:
means for receiving a digital image from a client;
means for rendering a line-art image from the digital image;
means for formatting a coloring book image from the line-art image.

37. A system comprising:
a processing unit to render a line-art image from a digital image and to create a coloring book image from the line-art image; and
a printer for printing the coloring book image.

38. The system of claim 37 wherein the processing unit further generates at least one color sample from the digital image, and assigns the at least one color sample to a corresponding image area of the line-art image.

39. The system of claim 38 wherein the processing unit further assigns an index number corresponding to the at least one sample color.

40. The system of claim 38 wherein the printer prints the index number with a name of the corresponding sampled color together with the coloring book image.

41. The system of claim 37 wherein the printer is located at a public kiosk.

42. The system of claim 38 wherein a fee is charged for the printing at the public kiosk.

43. The system of claim 37 wherein the processing unit and the printer are located at a public kiosk.

44. The system of claim 43 wherein a fee is charged for the use of the processing unit and printer at the public kiosk.

45. The system of claim 37 wherein the processing unit further combines the coloring book image with stock images to produce a coloring book storyboard.

46. The system of claim 37 wherein the digital image is selected from the group consisting of an eight-bit grayscale image, an eight-bit duotone image, an eight-bit paletted image, a sixteen-bit grayscale image, a twenty-four-bit color image, a thirty-two-bit color image, and a forty-eight-bit color image.

47. A computer readable medium comprising instructions, which when executed on a processor, perform a method comprising:
rendering a line-art image from a digital image;
formatting a coloring book image from the line-art image; and
printing the coloring book image.

48. A computer readable medium comprising instructions, which when executed on a processor, perform a method comprising:
receiving a digital image at a server;
rendering a line-art image from the digital image;
formatting a coloring book image from the line-art image;
transmitting the coloring book image to a client; and
printing the coloring book image at the client.

49. A computer readable medium comprising instructions, which when executed on a processor, perform a method comprising:
transmitting a digital image to a server;
receiving a coloring book image rendered from the digital image; and
printing the coloring book image.

50. A computer readable medium comprising instructions, which when executed on a processor, perform a method comprising:
receiving a digital image from a client;
rendering a line-art image from the digital image;
formatting a coloring book image from the line-art image.
